(19) United States
(12) Patent Application Publication
(10) Pub. No.: US 2011/0052856 A1
(43) Pub. Date: Mar. 3, 2011

(54) EXTRUDED STRIP

(76) Inventor: Josef Berthold, Wuergau/Schesslitz (DE)

(21) Appl. No.: 12/812,774

(22) PCT Filed: Jan. 15, 2009
(86) PCT No.: PCT/EP09/00219

§ 371 Date: Jul. 14, 2010

(30) Foreign Application Priority Data
Jan. 15, 2008 (DE) 20-2008-000-573.6

(51) Int. Cl. B32B 7/06; B05D 1/32; B05D 5/06

(52) U.S. Cl. 428/68; 427/259

(57) ABSTRACT

The present invention relates to a painted extruded strip, particularly for motor vehicles, having a main body (12) with a painted visible side and at least one sealing body (14) extruded onto the main body (12), wherein a protective film (44) is extruded onto the at least one sealing body (14), covering at least one sealing surface of the sealing body (14) and able to be removed following the painting.

The invention relates to [a] painted extruded strip, in particular for motor vehicles, in particular comprising a main body with a painted visible side, and at least one sealing body extruded onto the main body.

These extruded strips are characterized by low production costs because of the production method, and by an attractive appearance because of the painting. For example, the same color nuance as that of the base supporting the strip, such as the body of the motor vehicle, for example, can be selected. It is also possible to select a contrasting color, or a metallic paint that creates the impression of a chrome strip, for example. Furthermore, two color tones can be realized.

Various painting methods are used, such as conventional spray-painting, for example, or more recently also immersion painting. If the extruded strip has one or a plurality of sealing bodies, each of which rests on the supporting base, for example on the metal of the car body, with a sealing strip in a sealing fashion, at least the sealing surface must be covered prior to painting because paint on the sealing surface would impair the sealing function. Conventionally, a separate paint mask is used for this purpose to cover the sealing body, for example in form of an adhesive tape, which is affixed prior to painting. The paint mask [sic; sp] is then removed again after painting.

With the help of these separately applied paint masks, as described above, it is also possible to produce multi-color extruded strips.

The invention is based on the problem of producing, in a simplified manner, a painted extruded strip that has at least one unpainted region.

The object of the invention is attained in that at least one cover layer, which can be pulled off after the painting is completed, is extruded onto the extruded strip.

According to the invention, the separate production step of covering or masking the sealing body and/or the unpainted region becomes obsolete. All that is required is to modify the co-extrusion tool once in such a manner that the cover layer is co-extruded when the strip is extruded.

When using the cover layer to partially cover the visible side of the extruded strip to be painted, an attractive two-tone color scheme is obtained after the cover layer is pulled off. In the case of an extruded strip comprising a main body with a painted visible side and at least one sealing body extruded onto the main body, the cover layer can be advantageously extruded onto the sealing body, of which there is at least one, so that it covers at least one sealing surface of the sealing body. When painting the extruded strip, it is not necessary to ensure that the sealing surface remains free of paint. It is also easily possible to perform an immersion painting. After painting, the cover layer is pulled off to expose the sealing surface and ensure a dependable sealing function.

To facilitate the removal [pulling off] of the cover layer, it is provided in a further development of the invention that the cover layer is provided with a removal aid, which, if necessary, would also allow a mechanical removal of the cover layer. To that end, it is especially preferred to provide the cover layer with a freely protruding web, which can be grasped either manually or mechanically. The thickening on the free edge of the web, as proposed by the invention, provides an especially safe hold. For example, said thickening can be introduced into a channel of a processing station that connects to a painting station and an intermediate drying station. In the further course, when the channel increasingly moves away from the strip, the cover layer is increasingly pulled off the strip and removed.

The extruded strip, if applicable the main body, can be formed by a multi-layer plastic element, if applicable, or by a pure metal element. Especially preferred is a composite construction where the main body is formed by a preferably pre-formed metal band with a plastic layer, preferably a PVC layer, extruded thereon. The pre-formed metal band ensures the required stability and flexural strength, in particular for essentially equal thermal expansion as the supporting base of the strip, in particular the sheet metal of the car body. The additional plastic layer allows the use of a metal band with reduced wall strength, which in turn reduces the production costs. Various strip forms are conceivable. The development as a band-shaped main body with one each sealing body at both edges of the band is preferred.

A dependable sealing function is ensured if the sealing body, of which there is at least one, has a sealing lip. Because said sealing lip, by definition, rests on the supporting base, e.g. the metal car body, if applicable, with only a relatively small sealing surface, ideally with a sealing line, with an appropriately high surface pressure, a sufficient sealing action is ensured at all times.

To ensure in accordance with the invention that on the one hand, the cover layer can be pulled off easily, and that on the other hand, the paint adheres so completely to the surface of the cover layer that no paint bridges or paint bits are created, but rather that an evenly straight paint layer boundary line is formed, it is proposed that the sealing body is formed with an elastomer, and that the cover layer is formed with a thermoplastic.

Potential elastomers for the sealing body are preferably PVC [polyvinylchloride] or copolymers of PVC, and/or PP/EPDM- or SEBS- or SBS-based elastomers. As material for the cover layer, it is recommended that preferably a polyolefin is used, preferably polypropylene or polyethylene or their copolymers or their terpolymers, and/or the use of polyelastomers and/or of PVC or copolymers of PVC, especially preferably softened with the addition of softeners.

To adjust the properties of sufficient paint adhesion and good removal from the surface to be protected, the use of a mixture of two or a plurality of products from the aforementioned product groups may also lead to the goal.

A first preferred combination of materials of sealing body and cover layer is characterized in that the sealing body is formed with PVC or copolymers of PVC, preferably softened with the addition of softeners, and that the cover layer (44) is formed with polyolefin, preferably polypropylene or polyethylene, preferably their copolymers or terpolymers.

A preferred second alternative combination of materials of sealing body and cover layer is characterized in that the sealing body is formed with PP/EPDM- or SEBS- or SBS-based elastomers, and that the cover layer (44) is formed with thermoplastic polyurethane elastomers. Alternately, the cover layer can also be produced from PVC or copolymers of PVC, if applicable softened with softeners.

To further improve the adhesion of the paint on the cover layer so as to avoid paint bridges or paint bits when the cover layer is pulled off, it is furthermore proposed to subject the cover layer to an appropriate surface treatment, similar as the one practiced in the printing of plastic foils. Of the various options for surface treatments, the use of an appropriate primer has proven useful, with alternately or additionally there also being potential treatment measures of surface of the cover layer, which increase surface tension. This can be achieved in particular with flame treatment, plasma discharge or spark discharge (Korona). When a material with sufficient paint adhesion is used for the cover film, the pre-treatment step can be omitted.

Especially preferred is the use of the strip in accordance with the invention as a roof moulding strip [OR: trim strip], with other types of applications, as discussed earlier, also being possible, such as, for example, a strip that laterally abuts the motor vehicle.

The invention also relates to a method for the production of an extruded strip, in particular for motor vehicles, having a paint layer that only partially covers the strip, with the following steps: Masking the strip with a co-extruded, removable cover layer; painting the strip; and removing the cover layer. This method can be used to produce, with minimal effort, an extruded strip that has at least one unpainted region. This applies primarily when the cover layer is produced in the co-extrusion process together with the strip.

To obtain an especially good adhesion of the paint layer on the cover layer, which ensures a smooth, straight tear-off edge and thus painting boundary, it is proposed to subject the cover layer to a surface treatment prior to painting, preferably to a plasma treatment or a spark treatment.

The invention is explained in the following using the illustration as an example.

The illustration shows:

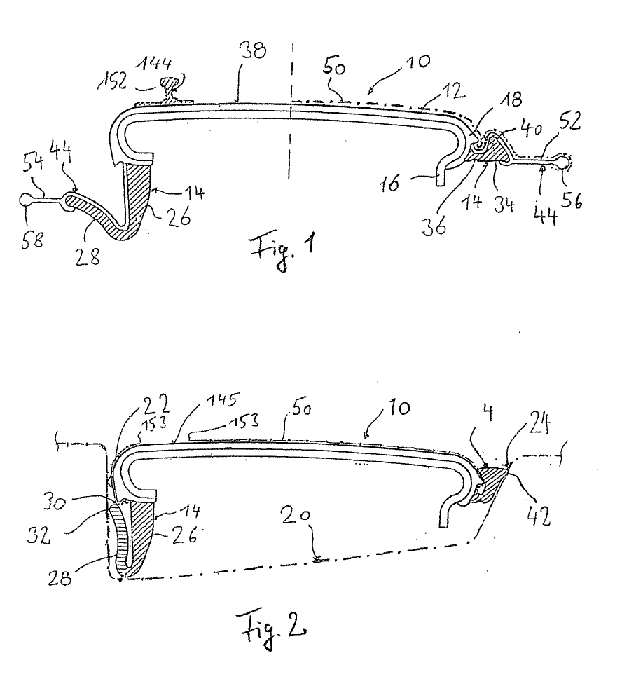

FIG. 1 a cross-section of a strip in accordance with the invention prior to painting (left half) and after painting (right half), but in each case prior to assembly; and

FIG. 2 a cross-section of a strip according to FIG. 1 in assembled condition.

The extruded strip in accordance with the invention is generally labeled with the reference symbol 10. It is comprised of a main body 12 with an approximately C-shaped cross-section and two sealing bodies 14 at the two edges of the band. The actual main body 12 has a metal band 16, which forms the interior side of the main body, as well as a plastic layer 18 that is extruded onto the external side of the C-form. The metal band 16 is preferably formed by a thin stainless steel or aluminum band, which is nevertheless rather stable due to the C-form, and the plastic layer 18 is preferably formed by a tough elastomer, preferably PVC [polyvinylchloride] with a hardness of Shore-D of 65 plus/minus 5.

Each of the two sealing bodies 14, on the other hand, are formed from a soft elastomer with a hardness of Shore—A in a range of 75 plus/minus 5. It is shown that each of the two sealing bodies 14 is extruded onto the external side of the plastic layer 18.

FIG. 2 shows a schematic representation of the assembly situation, where the strip 10, in form of a roof moulding [trim] strip, is inserted into a groove 20 in the car body; said groove has an approximately rectangular cross-section and is open at the top. Both sealing bodies 14 bear against the left lateral flank 22 and/or the right lateral flank 24 of the groove 20 in a sealing fashion. The sealing body 14, which is shown on the left in the figure, has an essentially V-shaped cross-section relative thereto, with a firm fixed leg 26 that protrudes from the main body 12 and a free leg 28 protruding there from. In the assembled condition according to FIG. 2, the free leg 28 is bent toward the fixed leg 26 so that its free edge 30 abuts the flank 22 in a sealing fashion with appropriate spring preload, ideally along a sealing line 32.

The sealing body 14, which is shown on the right in the figures, has a sealing section 34 formed like a hook, which is connected to the main body 12 by means of a cutoff section 36, with the cross-section of the material being slightly reduced accordingly. In the non-deformed initial position according to FIG. 1, section 34 protrudes from the main sealing body toward the right, i.e., in a direction that is parallel to the slightly bent upper side (=visible side) 38 of the strip 10. A projection 40 of section 34, which is formed as a sealing nose, points upward.

In the assembly position according to FIG. 2, on the other hand, section 34 is bent downward so that the projection 40 abuts the flank 24 with appropriate initial tension, again ideally forming a sealing line 42 with the body of the car.

The respective sealing surface and the sealing lines 32 and 42 must be kept free of paint because otherwise the sealing function is no longer ensured, in particular because of the clearly reduced elasticity due to the paint layer that has been applied.

Therefore, according to the present invention, one each cover layer in form of a protective film 44 is extruded onto the two sealing bodies 14 before the strip 10 is painted, i.e., it is extruded on the metal band 16 in the co-extrusion process with the plastic layer 18 and the respective sealing body 14, with the metal band 16 receiving an approximately C-shaped cross-sectional form before being introduced into the extrusion head with appropriate preforming. In doing so, it is sufficient if the respective sealing surface and the sealing lines 32, 42 are covered. Because a layer of paint on the sealing body 14 generally has a negative effect on the flexibility of said sealing body, in an especially preferred embodiment, the protective film 44 also covers the surface region of the two sealing bodies 14 between the sealing surface and main body 12. In the present case, the surface regions of the two sealing bodies 14, which point downward and/or toward the inside in FIG. 1, are without a protective film with a spray painted strip 10 (from top in FIG. 1), which facilitates the subsequent removal and requires less use of material. These surface regions remain free of paint if the strip in FIG. 1 is spray painted from the top.

On the other hand, in case of an immersion painting of the strip 10, which is also possible, the entire respective sealing body 14 would be respectively enclosed by a protective film 44.

The strip 10, which is thusly pretreated with two protective films 44, is then painted so that the paint layer 50, which is symbolized with a dash-dot line in FIG. 1 (right) and in FIG. 2, is obtained on the upper side of said strip. Said paint layer also runs across the upper side of the cover layer 44.

Then, after the paint layer 50 has dried, or at the latest prior to the assembly on the motor vehicle, the respective protective film 44 is pulled off at both edges of the strip 10. This is facilitated by the special form of the cover layer, e.g. by a respective web; in un-deformed condition of the two sealing bodies 14 according to FIG. 1, a web 52 protrudes laterally on the right and/or a web 54 protrudes laterally on the left. Both webs have a thickening that is approximately annular in cross-section so the protective film 44 can be pulled off.

Said protective film can be pulled off manually or mechanically. Thus, it is also conceivable to thread a thickening 56 and/or 58 into a fitted groove of an appropriate tool, with the groove increasingly moving away from the strip 10 in the direction of travel of the strip, which then ensures that the protective film 44 is pulled off automatically.

In accordance with the invention, the protective film 44 can be easily pulled off both sealing bodies without the risk of creating paint bridges or paint bits when the layer is pulled off. This is achieved with a special combination of materials of sealing body and protective film. Of the many potential combinations of materials, a sealing body of PVC has proven especially useful, which is preferably softened with the addition of softeners; a protective layer of polyolefin, preferably polypropylene or polyethylene, preferably their copolymers or terpolymers, has also proven useful. In particular, EVA (ethylene/vinyl acetate/copolymer) has proven useful as a material for the protective film. Alternately, it is also possible to form the sealing body with elastomers, in particular PP-(polypropylene)/EPDM-(ethylene/propylene/diene/terpolymer) or SEBS-(styrene/ethylene/bytylene [sic?]/styrene) or SBS-(styrene/butadiene/styrene)—based elastomers, with the protective film then being formed with thermoplastic polyurethane elastomers. Alternately PVC, copolymers of the PVC, if applicable also softened with softeners, are also possible.

The method in accordance with the invention thus provides that prior to painting an extruded strip comprising a main body with a visible side to be painted and at least one sealing body to be extruded onto the main body, a protective film is extruded onto the sealing body, of which there is at least one, which can be pulled off after painting; said protective film covers at least one sealing surface of the sealing body and is pulled off after painting or prior to assembly.

Another possible step in the method, which precedes the painting step, is the surface treatment of the protective film 44 to improve the adhesion of the paint on the protective film so that no paint bits or paint bridges are created during the subsequent separation.

The surface treatment can consist of applying a primer. Additionally or alternately, a treatment can be performed to increase the surface tension of the protective film. This is obtained in particular with flame treatment or plasma treatment or spark treatment (Korona), which improves the adhesion of hydrophilic paint, which is preferably used. This step is obsolete if the material of the cover film itself has sufficient paint adhesion.

The invention described above can not only be used advantageously for masking sealing bodies in case of extruded strips comprised of main body and sealing body and/or sealing bodies, but in general also for extruded strips with or without sealing body. The cover layer can also be used to partially mask the visible side of the extruded strip, which can yield appealing effects. FIGS. 1 and 2 indicate the use of a cover layer 144 to that effect on the visible side of the extruded strip 10 to explain this idea, specifically in FIG. 1 with a dashed outline, which leaves a corresponding paint-free surface strip 145 on the visible side of the strip 10 when it is removed after painting. Then the paint layer 50 follows on both sides of the strip 145, which respectively runs up to where the left and/or right sealing body 14 begins. A two-tone effect can be achieved if the paint layer 147 has a different color tone than the upper side of the main body 12. It is also possible to generate surface effects, such as, for example, if the upper side has a surface structure, in particular a roughness that is retained after painting in the region of the strip 145, but which is unlike the smooth surface of the paint layer 50 that follows on both sides.

With this second embodiment as well, the cover layer 144 can have an aid to pull off the layer, as is indicated by the free protruding web 152 and the thickening 158 in FIG. 1. Furthermore, it is also important in this embodiment that the paint dependably adheres to the cover layer 144 so that a clean tearing edge 153 of the paint layer 147 is formed when the cover layer 144 is pulled off. According to FIG. 2, the two tearing edges 153 form the boundaries of the exposed strip 145.

This means that the painted extruded strip in accordance with the invention can be produced in an especially economical manner, and has a very appealing appearance because of the painting. It is preferably used for motor vehicles, where it can be used in particular for trim strips or abutment strips.

1. Painted extruded strip, in particular for motor vehicles, characterized in that at least one cover layer (44; 144), which can be pulled off after painting, is extruded onto the extruded strip.

2. Extruded strip in accordance with claim 1, comprising a main body (12) with a painted visible side and at least one sealing body (14) extruded onto the main body (12), characterized in that a cover layer (44), which covers at least one sealing surface of the sealing body (14) and can be removed after painting, is extruded onto the sealing body (14), of which there is at least one.

3. Extruded strip (10) in accordance with claim 2, characterized in that the cover layer (44) essentially runs from the visible side to the sealing surface.

4. Extruded strip (10) in accordance with one of the preceding claims, characterized in that the cover layer (44) has a removal aid.

5. Extruded strip (10) in accordance with claim 4, characterized in that the removal aid is formed by a freely protruding web (52; 54; 152), preferably with a thickening (56; 58; 158) at the free edge of the web.

6. Extruded strip (10) in accordance with one of the preceding claims, characterized in that the extruded strip, if applicable the main body (12), is formed by a metal band (16) and a plastic layer (18), preferably a PVC [polyvinylchloride] layer, which is extruded onto said metal band.

7. Extruded strip (10) in accordance with one of the claims 2 to 6, characterized in that the band-shaped main body (12) has one each sealing body (14) at both edges of the band.

8. Extruded strip (10) in accordance with one of the claims 2 to 7, characterized in that there is at least one sealing body, which has a sealing lip (sealing line 32; 42).

9. Extruded strip (10) in accordance with one of the claims 2 to 8, characterized in that the sealing body (14) is formed with an elastomer, and that the cover layer (44) is formed with a thermoplast.

10. Extruded strip (10) in accordance with claim 9, characterized in that the sealing body (14) is softened with PVC or copolymers of PVC, preferably with the addition of softeners, and/or is formed with PP/EPDM- or SEBS- or SBS-based elastomers.

11. Extruded strip (10) in accordance with one of the claim 9 or 10, characterized in that the cover layer (44) is formed with a polyolefin, preferably polypropylene or polyethylene or their copolymers or terpolymers and/or with a polyurethane elastomer and/or with PVC or copolymers of PVC, preferably softened with the addition of softeners.

12. Extruded strip (10) in accordance with claims 10 to 11, characterized in that the sealing body (14) is formed with PVC or copolymers of the PVC, preferably with the addition of softeners, and that the cover layer (44) is formed with polyolefin, preferably polypropylene or polyethylene, preferably their copolymers or terpolymers.

13. Extruded strip (10) in accordance with claims 10 to 11, characterized in that the sealing body is formed with elastomers, in particular PP/EPDM- or SEBS- or SBS-based elastomers, and that the cover layer (44) is formed with thermoplastic polyurethane elastomers.

14. Extruded strip (10) in accordance with one of the preceding claims, characterized in that the cover layer (44) is surface-treated to improve the adhesion of the paint, preferably by means of a primer and/or measures to increase the surface tension.

15. Extruded strip (10) in accordance with one of the preceding claims, characterized in that it is developed as a roof moulding [trim] strip.

16. Method for the production of an extruded strip (10), in particular for motor vehicles, having a paint layer that only partially covers certain regions of the strip (10), with the following steps:
Masking the strip (10) with a removable cover layer (44) applied by extrusion;
Painting the strip (10); and
Pulling off the cover layer (44).

17. Method for the production of an extruded strip (10) in accordance with claim 16, characterized in that the cover layer (44) is produced in the coextrusion process together with the strip (10).

18. Method for the production of an extruded strip (10) in accordance with claim 16 or 17,
characterized in that the cover layer (44) is subjected to a surface treatment prior to painting, preferably a plasma treatment or spark treatment.
